(19) United States
(12) Patent Application Publication
(10) Pub. No.: US 2005/0184168 A1
(43) Pub. Date: Aug. 25, 2005

(54) Automatically refilling ultrasonic fog maker, recycling ultrasonic fog maker, and method of treating a medical condition using negative ions

(75) Inventor: Kuang Peng, Hampton, VA (US)

Correspondence Address: FOLEY AND LARDNER;SUITE 500, 3000 K STREET NW, WASHINGTON, DC, 20007, US

(73) Assignee: PENGS GROUP, INC.

(21) Appl. No.: 11/003,011

(22) Filed: Dec. 3, 2004

Related U.S. Application Data
(63) Continuation-in-part of application No. 10/950,817, filed on Sep. 28, 2004.
Application No. 10/950,817 is a continuation of application No. 10/295,023, filed on Nov. 15, 2002, now Pat. No. 6,799,730.

(51) Int. Cl. B05B 17/04

(52) U.S. Cl. 239/4; 239/102.1; 239/102.2

(57) ABSTRACT

An ultrasonic fog generator creates a fog of a liquid such as water. When the amount of liquid in the ultrasonic fog generator falls below a predetermined value, the liquid may be automatically refilled by a liquid source. A liquid recycling system may be provided to limit the amount of liquid in a fog that may otherwise undesirably condense in the ambient environment. The ultrasonic fog generator may be configured to release a fog periodically. Moreover, the periodically released fog may contain one or more fragrances. Further, a fog produced using water may contain negative ions that may be useful in treating a medical condition of a patient.

### CROSS-REFERENCE TO RELATED APPLICATIONS

This application is a continuation-in-part of U.S. patent application Ser. No. 10/950,817 filed Sep. 28, 2004, which, in turn, is a continuation application of U.S. patent application Ser. No. 10/295,023 (now U.S. Pat. No. 6,799,730) filed on Nov. 15, 2002. Both U.S. patent application Ser. No. 10/950,817 and U.S. patent application Ser. No. 10/295,023 are incorporated herein by reference in their entities.

### BACKGROUND OF THE INVENTION

The present invention relates to creating fog, which may be in the form of mist. More particularly, the invention relates to using fog or mist in a visually appealing display or as a means by which to treat a medical condition.

There are generally four types of visual vapor or fog generators on the market today. Carbon dioxide (“CO₂”) fog generators generate a visual fog using a solid block of CO₂ (i.e., dry ice) which is dropped into a bath of deionized (“DI”) water heated to 140° F. or higher. One disadvantage of CO₂ fog generators is that the fog quantity they produce is unregulated, i.e., the fog quantity cannot be readily applied in any situation without adjusting the size of the CO₂ block as the quantity of fog produced is largely based on the size of the block used. Further, in applications requiring a large amount of fog, the size of the CO₂ fog generator can become large and cumbersome. In addition, as the CO₂ block melts, the quantity of fog output from the fog generator diminishes and the temperature of the DI bath is lowered which, in time, will require a reheating of the water or adding more hot water thereto. Further, when the CO₂ block completely melts, it must be replaced by another costly CO₂ block.

Helium bubble generators, as the name implies, generate small helium filled bubbles of water that float in the air at almost neutral buoyancy. Unfortunately, helium bubble generators tend to produce a small quantity of bubbles that may fail to create a dense and realistic fog. Further, increasing the helium levels in a room may have a negative impact on the comfort of people in the room.

A third type of fog generator generates a fog by passing steam from boiling water through a bath of liquid nitrogen (“N₂”) creating a super cooled fog. Similar to the CO₂ block fog generator, liquid N₂ fog generators tend to be large and require a continuous supply of costly liquid N₂. Further, these fog generators may be hazardous because they require both a boiler to heat the water and extremely cold liquid N₂ to operate.

### SUMMARY OF THE INVENTION

Ultrasonic fog generators create fog by vibrating a liquid, which is typically water, using ultrasound. These traditional ultrasonic fog generators, however, suffer from a limited supply of water. Moreover, these fog generators may expel a fog having a high water vapor content that may readily condense on surrounding surfaces.

In light of the forgoing, what is needed is a fog generator that has a generally unlimited supply of necessary materials and that emits a dense fog that does not readily condense on surrounding surfaces and instead dissolves into the ambient air.

The invention herein contains multiple embodiments including an ultrasonic fog generator that includes, among other possible things: (a) a container configured to contain a liquid; (b) a liquid source configured to supply liquid to the container; and (c) a housing positioned in the container, the housing including, among other possible things: (i) a transducer configured to vibrate ultrasonically; (ii) a sensor configured to monitor a liquid level in the container; and (iii) a control system connected to the sensor and to the liquid source. If the liquid level falls below a lower limit, the control system is configured to send a refill signal to the liquid source instructing the liquid source to supply liquid to the container.

In a further embodiment of this ultrasonic fog generator, if the liquid level falls below the lower limit the control system may also be configured to eliminate a supply of power to the transducer thereby preventing the transducer from vibrating.

In another further embodiment of this ultrasonic fog generator, if the liquid level is at, or rises above, an upper limit, the control system may be configured to send a stop signal to the liquid source instructing the liquid source to stop supplying liquid to the container.

In another further embodiment of this ultrasonic fog generator, if the liquid level is at, or rises above, the upper limit, the control system may also be configured to initiate a supply of power to the transducer thereby enabling the transducer to vibrate.

In another further embodiment of this ultrasonic fog generator, the fog generator may also include a stand configured to maintain the container and the housing therein above a surface. Further, the transducer may be configured to transform liquid in the container into a fog that emanates from the container and falls toward the surface.

In another further embodiment of this ultrasonic fog generator, the fog generator may include a display that may be configured to alter an appearance of the fog. In addition, the display may include at least one light configured to radiate light of at least one color. Further, at least one of the lights may be configured to radiate light of at least two different colors.

In another further embodiment of this ultrasonic fog generator, the fog generator may include: (d) a deflecting surface; and (e) a fog conduit positioned in the container and configured to direct fog generated by the housing toward the deflecting surface; the deflecting surface may be configured to condense liquid in the fog into droplets. Further, the fog generator may also include: (f) one or more return ports that are configured to recycle the droplets into the container. In addition, a fan may be provided and be configured to direct the fog in a predetermined direction.

In another further embodiment of this ultrasonic fog generator, the liquid may be water. Further, the fog may be in the form of a mist.

In another further embodiment of this ultrasonic fog generator, the transducer may be configured to vibrate at below about 1.8 MHz, such as, for example, at about 1.7 MHz.

In another further embodiment of this ultrasonic fog generator, the liquid may include at least one fragrance that may be dispersed in the fog.

In another further embodiment of this ultrasonic fog generator, the fog generator may also include a fan that is configured to direct the fog in predetermined direction.

In another further embodiment of this ultrasonic fog generator, the control system may be configured to initiate power to the transducer periodically so that a fog produced from the liquid will be periodically released into the ambient environment.

Another embodiment of the invention addresses another fog generator. This fog generator includes, among other possible things: (a) a container configured to contain a liquid comprising at least one fragrance; and (b) a housing positioned in the container, the housing including, among other possible things: (i) a transducer configured to vibrate ultrasonically; and (ii) a control system electrically connected to the transducer. The control system is configured to initiate power to the transducer periodically so that a fog produced from the liquid and the at least one fragrance will be periodically released into the ambient environment.

In a further embodiment of this fog generator, the fog generator may also include a liquid source configured to supply liquid to the container.

In another further embodiment of this fog generator, the fog generator may also include a sensor configured to monitor a liquid level in the container.

In another further embodiment of this fog generator, if the liquid level falls below a lower limit, the control system may be configured to send a refill signal to the liquid source instructing the liquid source to supply liquid to the container.

In another further embodiment of this fog generator, if the liquid level falls below the lower limit, the control system may also be configured to eliminate a supply of power to the transducer thereby preventing the transducer from vibrating.

In another further embodiment of this fog generator, if the liquid level is at, or rises above, an upper limit, the control system may be configured to send a stop signal to the liquid source instructing the liquid source to stop supplying liquid to the container.

In another further embodiment of this fog generator, if the liquid level is at, or rises above, the upper limit, the control system may also be configured to initiate a supply of power to the transducer thereby enabling the transducer to vibrate.

In another further embodiment of this fog generator, the transducer may be configured to vibrate at below about 1.8 MHz, such as for example, at 1.7 MHz.

In another further embodiment of this fog generator, the fog generator may include a fan that is configured to direct the fog in a predetermined direction.

In another further embodiment of this fog generator, the ultrasonic fog generator may be configured to be plugged into a wall outlet.

In another further embodiment of this fog generator, a method for adding at least one fragrance to ambient air using this ultrasonic fog generator may be provided where the container contains a liquid that includes at least one fragrance. This method includes, among other possible steps: (1) vibrating ultrasonically the liquid comprising the at least one fragrance with the transducer, to create a fog of the liquid that includes the at least one fragrance; and (2) dispersing the fog into the ambient air.

In a further embodiment of this method, the method may also include the step of (3) monitoring a volume of the liquid comprising the at least one fragrance in the container with a sensor. Further, the method may also include the step of (4) stopping the vibrating of the transducer if the volume of the liquid that contains the at least one fragrance in the container, as measured by the sensor, is below a predetermined value or instructing a liquid supply to refill the container with additional liquid that contains the at least one fragrance.

In a further embodiment of this method, the step of vibrating ultrasonically the liquid that contains the at least one fragrance with the transducer may include vibrating the transducer at below about 1.8 MHz, such as, for example, at about 1.7 MHz.

Another embodiment of the invention addresses a method of ambient air freshening. This method includes, among other possible steps: (a) providing a container comprising a fragrant liquid; (b) vibrating ultrasonically the at least one fragrant liquid, to create a fog of the fragrant liquid; (c) emanating the fog into the ambient air; (d) monitoring an amount of the fragrant liquid in the container with a sensor; and at least one of the following steps: (i) stopping the vibrating if the amount of the fragrant liquid in the container, as measured by the sensor, is below a predetermined value; and/or (ii) instructing a liquid supply to refill the container with additional fragrant liquid.

In a further embodiment of this method, the step of vibrating ultrasonically the fragrant liquid may include vibrating the fragrant liquid at below about 1.8 MHz, such as, for example, at about 1.7 MHz.

Another embodiment of the invention addresses a method of treating a medical condition of a patient. This method includes, among other possible steps: (a) vibrating water ultrasonically to create a fog containing negative ions; (b) consuming the negative ions by absorbing the ions through the patient's skin and/or by inhaling the negative ions; and (c) treating a medical condition using the consumed negative ions.

In a further embodiment of this medical treatment method, the step of vibrating water ultrasonically may be performed using an ultrasonic fog generator of any of the types previously discussed.

In another further embodiment of this medical treatment method, the step of vibrating water ultrasonically may include vibrating the water at below about 1.8 MHz, such as, for example, at about 1.7 MHz.

In another further embodiment of this medical treatment method, the medical condition may be a mental condition, a skin condition, or other health condition. Further, the mental condition may be depression. In addition, the skin condition may be a degenerative skin condition.

These and other features, aspects, and advantages of the present invention will become more apparent from the following description, appended claims, and accompanying exemplary embodiments shown in the drawings.

### BRIEF DESCRIPTION OF THE DRAWINGS

The accompanying drawings, which are incorporated in and constitute a part of the specification, illustrate embodiments of the invention and together with the description, serve to explain the principles of the invention.

FIG. 1 is a perspective view of a housing for use in an ultrasonic fog generator, the housing having a plurality of lights thereon;

FIG. 2 is a cross-sectional view of the housing of FIG. 1 showing an ultrasonic transducer, a control system interposed between a power source and the transducer, the cross-section being taken along line II-II in FIG. 1;

FIG. 3 is a perspective view of a fog generator that includes the housing of FIG. 1 provided in a container of liquid;

FIG. 4 is a cross-sectional view of a fog generator in which a container has a light diffuser in the form of faux ice therein, the ice covering a housing of the type shown in FIG. 1;

FIG. 5 is a side view of an alternate embodiment fog generator that incorporates a refilling system, the housing of FIG. 1, and the container of FIG. 3 supported by a stand;

FIG. 6 is a cross-sectional view of the housing of FIG. 1, the cross-section being taken along line VI-VI in FIG. 1;

FIG. 7 is a side view of an alternate embodiment fog generator, which incorporates a deflecting surface to reduce liquid loss, a housing of the type of FIG. 1, and a refilling system of the type shown in FIG. 5; and

FIG. 8 is a perspective view of an alternate embodiment fog generator, which serves as a self-contained fragrance disperser.

### DETAILED DESCRIPTION

Reference will now be made in detail to presently preferred embodiments of the invention, which are illustrated in the drawings.

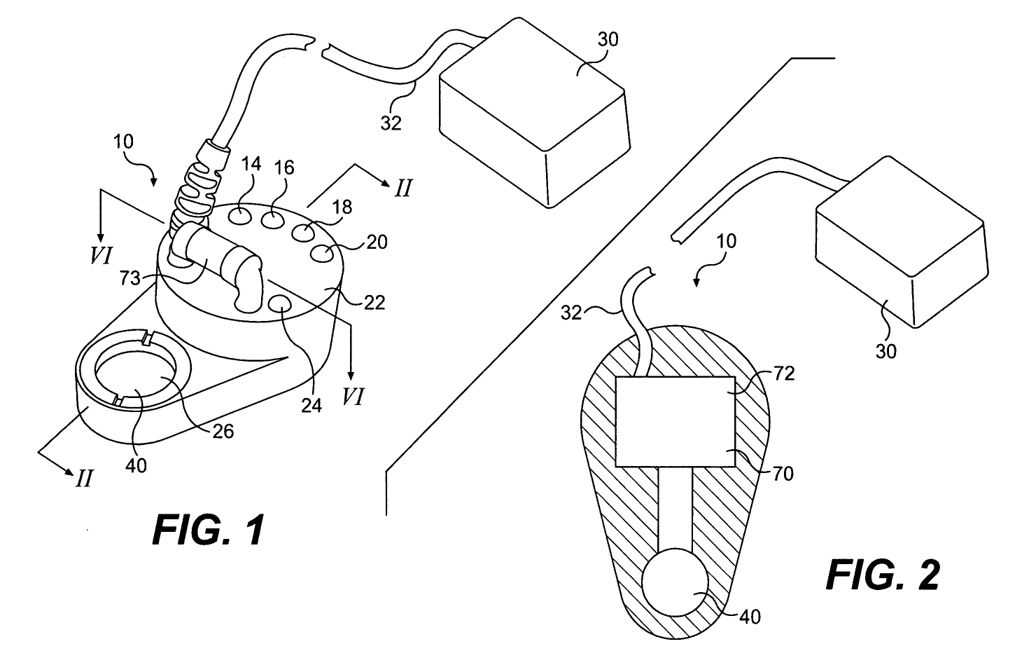

FIG. 1 is a perspective view of a housing 10 for use in an ultrasonic fog generator. The housing 10, which is preferably sized to be hand-held, has a top side 22 that includes a plurality of lights 14, 16, 18, 20. Each of the lights 14, 16, 18, 20 is adapted to emit a particular color of light which may be the same as or different than the color emitted by one or more of the other lights 14, 16, 18, 20. In addition, each of the lights 14, 16, 18, 20 may be adapted to change colors during use, i.e., the colors may be variable. Power for the lights 14, 16, 18, 20 is provided by a power source 30 (e.g., a wall outlet or battery, which hereafter includes both non-rechargeable and rechargeable batteries) and is delivered to the housing by a power cord 32, as later described in detail.

In addition to the lights 14, 16, 18, 20, the top side 22 of the housing 10 also includes an indicator lamp 24, an ultrasound depression 26 housing a transducer 40, and a sensor 73 of a control system 70 (later described in detail). The indicator lamp 24 contains a light source (such as a light emitting diode (“LED”), a halogen bulb, other light source, and/or a combination of light sources), which will continuously radiate light when the housing 10 is connected to the power source 30.

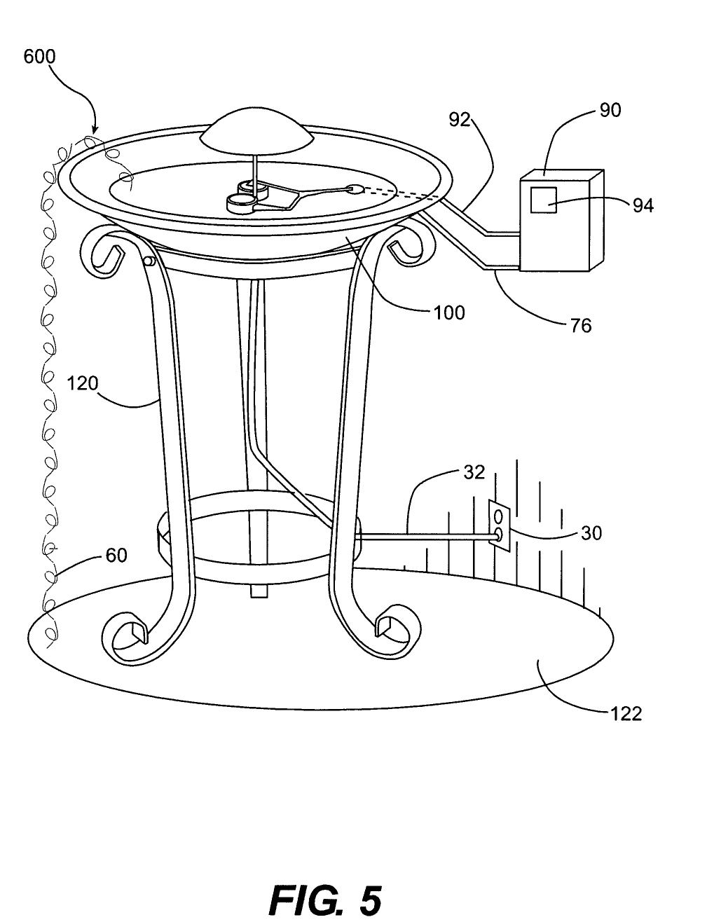

As previously mentioned, the ultrasound depression 26 houses a transducer 40 contained within the housing 10. The transducer 40 may be a ceramic material that is adapted to vibrate ultrasonically and that is electrically connected to the power source 30. The ceramic material can change electrical oscillations into mechanical oscillations. It is within the ultrasound depression 26 that a conductive or at least semiconductive liquid 50 will be converted to a fog 60 (see FIG. 5), which may be in the form of a mist, depending on the size of the droplets released into the air. The liquid 50 may be water, a pharmaceutical, a fragrance, a combination of any of these, or other liquid. Preferably, the housing 10 will be submerged between about 1.0″ and about 2.0″ and preferably at about 1.5″ in the liquid 50.

The liquid 50 within the ultrasound depression 26 is oscillated by the transducer 40 within the housing 10 at between about 1.6 MHz and about 1.8 MHz and preferably at about 1.7 MHz. A variety of ultrasonic transducers manufactured by Techsin Electronic Co. Ltd. (China) are capable of producing these oscillations; one preferable model is sold under product no. DH-24B. Another capable transducer is described in U.S. Pat. No. 6,361,024. One transducer 40 capable of producing such oscillations is shown in FIG. 2, which is a cross-sectional view of the housing of FIG. 1 taken along line II-II therein. As shown in FIG. 2, in addition to the ultrasonic transducer 40, the housing 10 also contains a control system 70 (later described in detail).

To power the transducer 40, it should be readily apparent that the power source 30 may be any conventional power source such as a wall outlet providing AC current or a DC battery. The type of power source 30 employed will, however, determine whether an AC/DC converter is necessary. In one embodiment, the power used by the transducer 40 is 24V of DC voltage. As a result, if an AC power source is used, a transformer and/or other mechanism (e.g., a rectifier) may be necessary.

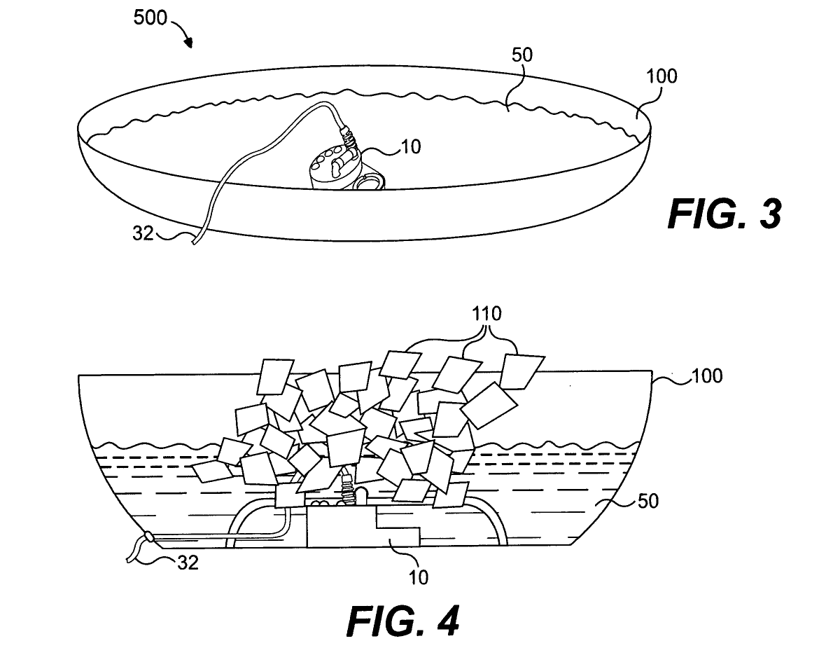

FIG. 3 is a perspective view of a fog generator 500 that includes the housing 10 of FIG. 1 in a container 100 of liquid 50. As previously mentioned, the liquid 50 may be water, a pharmaceutical, a fragrance, a combination of any of these, or other liquid. Preferably, the liquid 50 is water with or without at least one fragrance therein. The housing 10 is placed in the container 100 such that it is submerged in the liquid 50. Depending on whether the power cord 32 (and its connection to the housing 10) is liquid permeable, the power cord 32 may (as shown in FIG. 4) or may not (as shown in FIG. 3) be submerged. Regardless, the housing 10 is submerged to a depth such that the transducer 40 will cause the liquid near the surface of the liquid 50 to oscillate. As the liquid 50 near the surface oscillates, it will evaporate in the form of a visual fog or mist. The density of the fog or mist will depend on the depth at which the housing 10 is submerged in the liquid 50.

In conjunction with the container 100, the housing 10 (and the lights 14, 16, 18, 20) can be incorporated into a visually appealing display. For example, as shown in FIG. 4, a light diffuser 110 (such as a pile of faux ice) may be added to the container 100 to substantially cover the housing 10. The light diffuser 110 may be formed of plastic, quartz, a clear polymer, or other clear generally solid material that will not dissolve in the liquid 50. Further, preferably, the light diffuser 110 will not chemically react or interact with the liquid 50. In this embodiment, the light emitted by the lights 14, 16, 18, 20 will radiate through and illuminate the light diffuser 110.

Regardless of whether a light diffuser 110 is provided, the container 100 may be supported by a stand 120, thereby maintaining the container 100 above a surface 122. For example, a fog generator 600 shown in FIG. 5 incorporates a stand 120 so that when the fog is emitted by the liquid 50 in the container 100, it may fall to the surface 122, provided the fog is more dense than the ambient air surrounding the container 100. In addition, the stand 120 may be joined to a liquid source 90, as later described in detail.

With respect to FIGS. 2 and 5, power is delivered to the transducer 40 from the power source 30 via a power cord 32 and the control system 70. If the volume of the liquid 50 above the housing 10 in the container 100 (as measured by the control system 70) is below a predefined lower limit, the control system 70 may limit the amount of current/voltage from the power source 30 supplied to the transducer 40 and/or may automatically instruct the liquid source 90 to add (using a pump 94) liquid 50 to a container 100. When the volume of the liquid 50 above the housing 10 in the container 100 is at or above a predefined upper limit, the control system 70 can increase the current/voltage to the transducer 40 (thereby enabling the transducer 40 to oscillate) and/or instruct the liquid source 90 to stop adding liquid 50 (by turning off the pump 94) to the container 100.

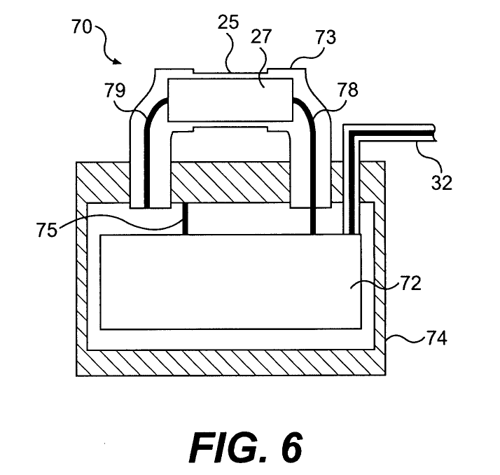

The control system 70, which will now be explained in detail with respect to FIG. 6, is described in detail in Chinese Patent Document No. ZL 96,236,955.1, which is incorporated herein by reference. As shown in FIG. 6 (which is a cross-sectional view of the housing of FIG. 1 taken along line VI-VI thereof), there is provided a circuit board 72 that, in conjunction with the control system 70, controls whether power/voltage travels from the power source 30 to the transducer 40. The circuit board 72 also controls whether an electrical signal (e.g., a “refill” or a “stop” signal) is transmitted to the liquid source 90 via an electrical connection 76 (shown in FIG. 5).

Connected electrically to the circuit board 72 is a first conductor 78 (e.g., a wire) that, in turn, is connected to a volume sensor 73. The sensor 73, which projects out of the housing 10, includes an insulation wrapping 25 and contains a material 27 that has a variable resistance; the material 27 may be copper. For example, the resistance of the material could change in response to the temperature of the liquid 50; the temperature presumably being lower in a bottom portion of the container 100 holding the liquid 50 than in an upper portion thereof. For instance, a change in resistance based on a change is temperature may be governed by the following equation:
R_{T}=R₀[1+α(T−T₀)],
where R_{T} is the resistance at temperature “T”, R₀ is the resistance at a reference temperature “T₀”, and α is a coefficient of resistivity for a given material. By way of another example, the resistance of the material 27 could vary with the pressure applied thereto by the liquid 50, the pressure being greater in a bottom portion of the container 100 than in an upper portion thereof. Such a change in resistance could be affected by a pressure sensitive resistor. However, the invention is not limited to any particular property that may alter the resistance of the material 27.

As the sensor 73 is lowered in a liquid 50 (i.e., as the depth of submersion increases), the resistance of the material 27 correspondingly increases. As a result, as the depth of the sensor 73 increases, the voltage across the sensor 73 will increase, provided current remains substantially constant. In addition, the portion of the wrapping 25 on the exterior of the sensor 73 that passes through the top side 22 of the housing 10 may be sealed with laminate plastic and/or rosin glue.

On an opposite end of the sensor 73 there is provided a second conductor 79. When the housing 10 is immersed in a liquid 50 and the resistance of the material 27 increases, the voltage at the second conductor 79 increases. As the second conductor 79 is insulated by the wrapping 25, the wrapping 25 acts as a dielectric between the second conductor 79 and the liquid 50, i.e., the second conductor 79 and the liquid 50 form a capacitor. As the voltage experienced by the second conductor 79 increases, the capacitance between the second conductor 79 and the liquid 50 will also increase.

As a result of the capacitance between the second conductor 79 and the liquid 50, current will flow in the liquid 50 (i.e., the other “plate” of the capacitor) and will pass through the conductive outer casing 74 (which, for example, may be formed from a metallic material such as chrome or copper) and back into the circuit board 72 via a third conductor 75, with a variable voltage. When the voltage at the third conductor reaches a predetermined level, a comparator (not shown) will act to direct the current to the transducer 40, thereby enabling the transducer 40 to oscillate, preferably ultrasonically.

If, however, the voltage at the third conductor is below the predetermined level, the circuit board 72 may send a refill signal to the liquid source 90 via the electrical connection 76. The liquid source 90 acting in response to the refill signal may use the pump 94 to force liquid 50 though a conduit 92 and into the container 100. When a sufficient amount of liquid 50 has been received in the container 100 and the housing 10 is sufficiently submerged, the voltage at the third conductor will rise about the predetermined level; as a result, the circuit board 72 can send a stop signal to the liquid source 90 via the electrical connection 76. In response to the stop signal, the liquid source 90 may stop pumping liquid 50 into the container 100.

It should be noted that as the power through housing is DC current/voltage, there is no substantial risk of electrical shock from the current in the liquid 50. However, caution is always advised when using electrical appliances in or near a liquid such as water.

In light of the aforementioned, the depth of the water affects the sensor 73 and the voltage thereacross such that the sensor 73 acts as a switch. It should also be noted that as the sensor 73 is insulated (by the insulation wrapping 25) from the liquid 50, oxidation of the sensor 73 will be substantially inhibited.

Absent a control system 70, if the housing 10 were insufficiently submerged, the transducer 40 may oscillate the liquid near the surface to such a degree that liquid, rather than fog, may be ejected from the container 100. Further, all of the liquid 50 on top of the housing 10 could be ejected from the container 100, thereby causing the housing 10 to operate without any liquid thereon. Moreover, operating the housing 10 without any liquid to oscillate not only wastes power, it may damage the housing 10 (e.g., by overheating the ceramic transducer 40).

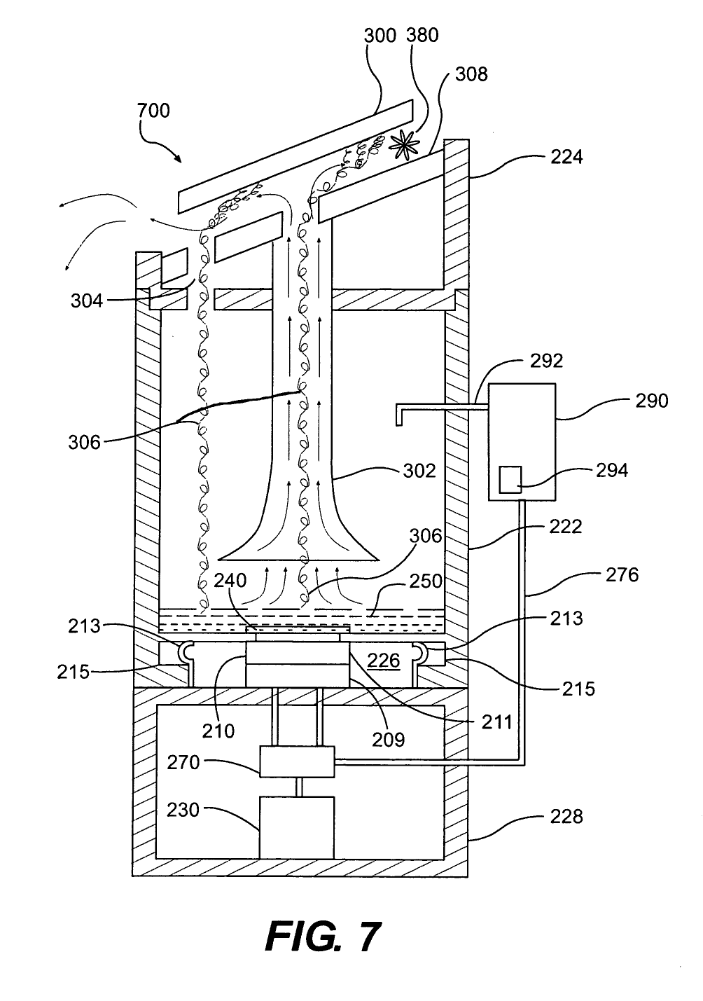

Another fog generator 700 embodiment, which is shown in FIG. 7, addresses the problem in the prior art regarding the amount of liquid present in a fog produced by an ultrasonic generator. In this embodiment, an ultrasonic housing 210 includes a transducer 240 that is positioned within a liquid container 222 and a pair of switch elements 209, 211 that are positioned in a chamber 226. The transducer 240 is electrically connected, through a lower wall of the container 222, to the upper switch element 211. As the upper switch element 211 is fixed to the underside of the container 222 and as the lower switch element 209 is fixed to the lower side of the chamber 226, no electrical connection is made when the container 222 and the chamber 226 are separated. However, when the container 222 is positioned atop the chamber 226 and pushed downward, spring elements 213 will bend forward and then releaseably snap backward into grooves 215, thereby immobilizing the container 222 on the chamber 226 and electrically connecting the switch elements 209, 211.

Similar to the previously described embodiment, the housing 210 is powered via a power source 230 (e.g., outlet or battery) and includes a control system 270. Both the power source 230 and the control system 270 are housed within a lower containment unit 228 that is separated from the chamber 226, except for the connection between the lower switch element 209 and the control system 270. The control system 270 is connected to the lower switch element 209 and to a liquid source 290. A circuit board (not shown) of the control system 270 acts in the same manner as the circuit board 72 of the previously described embodiment. Specifically, the circuit board controls current/voltage to the transducer 240 and is configured to send signals to the liquid source 290 regarding whether additional liquid 250 should be pumped (via a pump 294) through a conduit 292 and into the container 222.

A cover unit 224 is provided to substantially enclose the container 222, thereby inhibiting access to the liquid in the container 222. The cover unit 224 also supports a deflecting surface 300. A fog conduit 302 provided in the container 222 directs fog upward toward the sloped deflecting surface 300, as shown by the arrows in FIG. 7. Although the fog conduit 302 is shown as being somewhat funnel-shaped, this is not required. Rather, all that is required is a conduit by means of which the fog generated by the transducer 240 is directed upward toward the deflecting surface 300.

When the fog contacts the deflecting surface 300, if the fog has a high liquid content, the liquid content will condense on the underside of the deflecting surface 300 as droplets 306. When the droplets 306 fall, they will contact a sloped surface 308 and will travel down the sloped surface 308 (under the force of gravity). As the droplets 306 travel down the sloped surface 308, they will fall back into the container 222 (and mix with the liquid 250 therein) either through the conduit 302 or through a drain hole 304. As a result, the liquid 250 that was not completely converted into the fog is recycled rather than being released into the ambient environment.

In contrast, the fog that does not condense on the underside of the deflecting surface 300 may emanate radially outward and subsequently fall toward a surface (such as the surface 122 shown in FIG. 5). In this fashion, the fog may have an appearance substantially similar to that which is generated when a solid block of CO₂ (i.e., dry ice) is placed in a bath of water.

Although not required in this embodiment, a fan 380 may be provided to direct the fog and/or to enable the fog to move more quickly through the ambient environment. Moreover, although the fan 380 is shown as being between the sloped deflecting surface 300 and the sloped surface 308, the fan 380 could be located elsewhere or alternately directed. For example, the fan 380 could be located on top of the sloped deflecting surface 300.

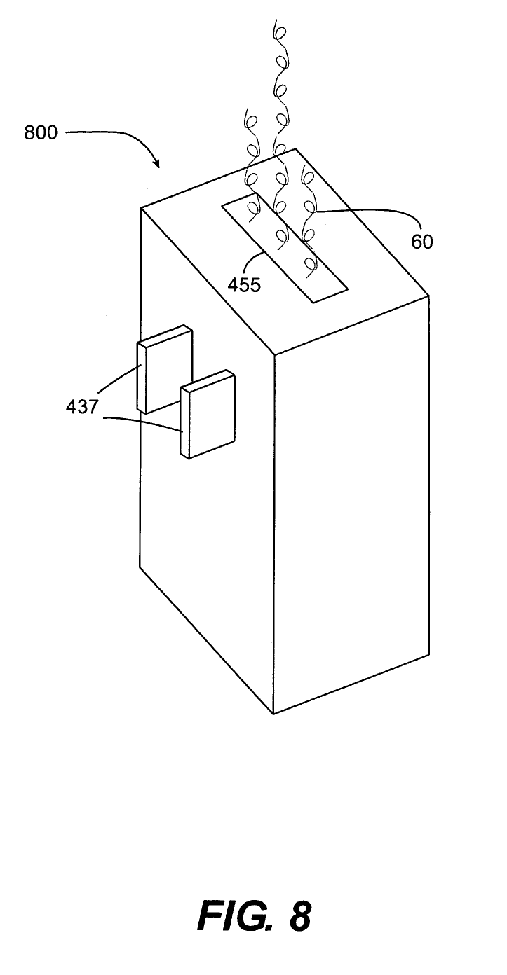

Another fog generator according to the present invention is in the form of a self-contained fragrance emitter 800, as shown in FIG. 8. This emitter 800 contains a housing 10 (not shown) of the type shown in FIG. 1, which is provided in a quantity of liquid that contains one or more fragrances (e.g., perfume, potpourri, etc.). The liquid and the fragrance(s) therein are turned into a fog when the transducer 40 oscillates. As a result, the fragrance may be emitted, in fog form, through a window 455.

Similar to the aforementioned embodiments, this emitter 800 may be powered by a power source 30 such as a standard wall outlet or a battery. Preferably, the emitter 800 of this embodiment will be plugged, via prongs 437, into a standard wall outlet. In addition, the housing 10 may have an alternate circuit board (not shown) that is configured to periodically provide power, from the power source 30, to the transducer 40. As a result, a dose of fragrance may be likewise periodically emitted (through the window 455) into the ambient environment in fog form when the liquid containing the fragrance is periodically oscillated. For example, the circuit board of the emitter 800 may be programmed to provide power to the transducer every fifteen minutes for a total period of thirty seconds.

Many uses are readily apparent for this type of self-contained fog generator 800. For example, the fog generator 800 may be located in areas subject to foul odors such as for example, rest rooms, loading docks, trash chutes, etc. As a result, the fog generator 800 may provide a periodic dose of a pleasant fragrance that may combat otherwise foul odors.

Any of the aforementioned embodiments of the invention may be used by health professionals and/or consumers for purposes of treating a medical condition such as, for example, skin disorders and/or depression. Specifically, if water is used as the liquid to be oscillated into a fog, the fog that is produced will be rich in negative ions, much like a mist produced by a waterfall. Negative ions are widely known to aid in many medical healing processes including, rejuvenating skin, eliminating depression, etc. See www.webmd.com. As a result, a method according to the present invention, may use any of the aforementioned fog generators 500, 600, 700, 800 to release negative ions that may be consumed by a patient (e.g., by being absorbed through the skin and/or by being inhaled into the lungs) to treat a medical condition such as, for example, skin disorders and/or depression.

Although the aforementioned describes embodiments of the invention, the invention is not so restricted. It will be apparent to those skilled in the art that various modifications and variations can be made to the disclosed preferred embodiments of the present invention without departing from the scope or spirit of the invention. Accordingly, it should be understood that the apparatuses and methods described herein are illustrative only and are not limiting upon the scope of the invention, which is indicated by the following claims.

1. An ultrasonic fog generator comprising:
a container configured to contain a liquid;
a liquid source configured to supply liquid to the container; and
a housing positioned in the container, the housing comprising:
a transducer configured to vibrate ultrasonically;
a sensor configured to monitor a liquid level in the container; and
a control system connected to the sensor and to the liquid source,
wherein if the liquid level falls below a lower limit, the control system is configured to send a refill signal to the liquid source instructing the liquid source to supply liquid to the container.

2. The ultrasonic fog generator according to claim 1, wherein if the liquid level falls below the lower limit the control system is also configured to eliminate a supply of power to the transducer thereby preventing the transducer from vibrating.

3. The ultrasonic fog generator according to claim 1, wherein if the liquid level is at, or rises above, an upper limit, the control system is configured to send a stop signal to the liquid source instructing the liquid source to stop supplying liquid to the container.

4. The ultrasonic fog generator according to claim 3, wherein if the liquid level is at, or rises above, the upper limit, the control system is also configured to initiate a supply of power to the transducer thereby enabling the transducer to vibrate.

5. The ultrasonic fog generator according to claim 1, further comprising:
a stand configured to maintain the container and the housing therein above a surface, wherein the transducer is configured to transform liquid in the container into a fog that emanates from the container and falls toward the surface.

6. The ultrasonic fog generator according to claim 5, further comprising:
a display that is configured to alter an appearance of the fog.

7. The ultrasonic fog generator according to claim 6, wherein the display comprises at least one light configured to radiate light of at least one color.

8. The ultrasonic fog generator according to claim 7, wherein at least one of the lights is configured to radiate light of at least two different colors.

9. The ultrasonic fog generator according to claim 1, further comprising:
a deflecting surface; and
a fog conduit positioned in the container and configured to direct fog generated by the housing toward the deflecting surface.

10. The ultrasonic fog generator according to claim 9, wherein the deflecting surface is configured to condense liquid in the fog into droplets, and wherein the fog generator further comprises:
one or more return ports that are configured to recycle the droplets into the container.

11. The ultrasonic fog generator according to claim 9, further comprising:
a fan that is configured to direct the fog in a predetermined direction.

12. The ultrasonic fog generator according to claim 1, wherein the liquid is water.

13. The ultrasonic fog generator according to claim 12, wherein the fog is in the form of a mist.

14. The ultrasonic fog generator according to claim 1, wherein the transducer is configured to vibrate at below about 1.8 MHz.

15. The ultrasonic fog generator according to claim 1, wherein the transducer is configured to vibrate at about 1.7 MHz.

16. The ultrasonic fog generator according to claim 1, wherein the liquid comprises at least one fragrance that is dispersed in the fog.

17. The ultrasonic fog generator according to claim 1, further comprising:
a fan that is configured to direct the fog in a predetermined direction.

18. The ultrasonic fog generator according to claim 1, wherein the control system is configured to initiate power to the transducer periodically so that a fog produced from the liquid will be periodically released into the ambient environment.

19. An ultrasonic fog generator comprising:
a container configured to contain a liquid comprising at least one fragrance; and
a housing positioned in the container, the housing comprising:
a transducer configured to vibrate ultrasonically;
a control system electrically connected to the transducer,
wherein the control system is configured to initiate power to the transducer periodically so that a fog produced from the liquid and the at least one fragrance will be periodically released into the ambient environment.

20. The ultrasonic fog generator according to claim 19, further comprising:
a liquid source configured to supply liquid to the container.

21. The ultrasonic fog generator according to claim 20, further comprising:
a sensor configured to monitor a liquid level in the container.

22. The ultrasonic fog generator according to claim 21, wherein if the liquid level falls below a lower limit, the control system is configured to send a refill signal to the liquid source instructing the liquid source to supply liquid to the container.

23. The ultrasonic fog generator according to claim 22, wherein if the liquid level falls below the lower limit, the control system is also configured to eliminate a supply of power to the transducer thereby preventing the transducer from vibrating.

24. The ultrasonic fog generator according to claim 21, wherein if the liquid level is at, or rises above, an upper limit, the control system is configured to send a stop signal to the liquid source instructing the liquid source to stop supplying liquid to the container.

25. The ultrasonic fog generator according to claim 24, wherein if the liquid level is at, or rises above, the upper limit, the control system is also configured to initiate a supply of power to the transducer thereby enabling the transducer to vibrate.

26. The ultrasonic fog generator according to claim 19, wherein the transducer is configured to vibrate at below about 1.8 MHz.

27. The ultrasonic fog generator according to claim 19, wherein the transducer is configured to vibrate at about 1.7 MHz.

28. The ultrasonic fog generator according to claim 19, further comprising:
a fan that is configured to direct the fog in a predetermined direction.

29. The ultrasonic fog generator according to claim 19, wherein the ultrasonic fog generator is configured to be plugged into a wall outlet.

30. A method for adding at least one fragrance to ambient air using the ultrasonic fog generator according to claim 19, wherein the container contains a liquid comprising at least one fragrance, the method comprising the steps of:
vibrating ultrasonically the liquid comprising the at least one fragrance with the transducer, to create a fog of the liquid comprising the at least one fragrance; and
dispersing the fog into the ambient air.

31. The method according to claim 30, further comprising the step of:
monitoring a volume of the liquid comprising the at least one fragrance in the container with a sensor.

32. The method according to claim 31, further comprising the step of:
stopping the vibrating of the transducer if the volume of the liquid comprising the at least one fragrance in the container, as measured by the sensor, is below a predetermined value; or
instructing a liquid supply to refill the container with additional liquid comprising the at least one fragrance.

33. The method according to claim 30, wherein the step of vibrating ultrasonically the liquid comprising the at least one fragrance with the transducer comprises:
vibrating the transducer at below about 1.8 MHz.

34. The method according to claim 30, wherein the step of vibrating ultrasonically the liquid comprising the at least one fragrance with the transducer comprises:
vibrating the transducer at about 1.7 MHz.

35. A method of ambient air freshening, the method comprising the steps of:
providing a container comprising a fragrant liquid;
vibrating ultrasonically the at least one fragrant liquid, to create a fog of the fragrant liquid;
emanating the fog into the ambient air;
monitoring an amount of the fragrant liquid in the container with a sensor; and
comprising at least one of the following steps:
stopping the vibrating if the amount of the fragrant liquid in the container, as measured by the sensor, is below a predetermined value; and/or
instructing a liquid supply to refill the container with additional fragrant liquid.

36. The method according to claim 35, wherein the step of vibrating ultrasonically the fragrant liquid comprises:
vibrating the fragrant liquid at below about 1.8 MHz.

37. The method according to claim 35, wherein the step of vibrating ultrasonically the fragrant liquid comprises:
vibrating the fragrant liquid at about 1.7 MHz.

38. A method of treating a medical condition of a patient, the method comprising the steps of:
vibrating water ultrasonically to create a fog containing negative ions;
consuming the negative ions by absorbing the ions through the patient's skin and/or by inhaling the negative ions; and
treating a medical condition using the consumed negative ions.

39. The method according to claim 38, wherein the step of vibrating water ultrasonically is performed using an ultrasonic fog generator, the ultrasonic fog generator comprising:
a container configured to contain the water;
a water source configured to supply water to the container; and
a housing positioned in the container, the housing comprising:
a transducer configured to vibrate ultrasonically;
a sensor configured to monitor a liquid level of the water in the container; and
a control system connected to the sensor and to the water source,
wherein if the liquid level falls below a lower limit, the control system is configured to send a refill signal to the water source instructing the water source to supply water to the container.

40. The method according to claim 38, wherein the step of vibrating water ultrasonically includes:
vibrating the water at below about 1.8 MHz.

41. The method according to claim 38, wherein the step of vibrating water ultrasonically includes:
vibrating the water at about 1.7 MHz.

42. The method according to claim 38, wherein the medical condition is selected from the group consisting of a mental condition and a skin condition.

43. The method according to claim 42, wherein the mental condition is depression.

44. The method according to claim 42, wherein the skin condition is a degenerative skin condition.
